(19) United States
(12) Patent Application Publication
(10) Pub. No.: US 2012/0205833 A1
(43) Pub. Date: Aug. 16, 2012

(54) PELLETIZING HIGH MELT FLOW POLYSTYRENE

(75) Inventors: Paul Martin, Baton Rouge, LA (US); Tom Braun, Baton Rouge, LA (US); Joe German, Prarieville, LA (US); Clint Jeffus, Baton Rouge, LA (US); Moises Rached, Prarieville, LA (US); John Tomlinson, Prarieville, LA (US); Steven Lejeune, Gonzales, LA (US); Jose Sosa, Deer Park, TX (US)

(73) Assignee: Fina Technology, Inc., Houston, TX (US)

(21) Appl. No.: 13/025,229

(22) Filed: Feb. 11, 2011

(51) Int. Cl. B29C 47/08

(52) U.S. Cl. 264/151; 425/112

(57) ABSTRACT

Methods and systems for pelletizing high melt flow polystyrene are described herein. The method generally includes providing a polystyrene including a melt flow index of about 16 g/10 min to about 34 g/10 min; extruding a strand of the polystyrene through a die head, wherein a temperature of the polystyrene at the die head is from about 370° to about 430° F.; and moving the strand through a bath, wherein a temperature of the bath is from about 95° to about 145° F.

### FIELD

Embodiments of the disclosed invention generally relate to the formation of high melt flow polystyrene pellets.

### BACKGROUND

General purpose polystyrene (GPPS), also referred to as crystal grade polystyrene, is made from styrene, a vinyl aromatic monomer that can be produced from petroleum. GPPS is useful in a variety of applications. One common application of GPPS is injection molding, for the production of molded plastic products, such as cups and utensils. Injection molding commonly involves feeding pellets of GPPS to an injection molding machine in order to produce molded plastic products.

When using GPPS pellets for injection molding, it is desirable for the GPPS pellets to have high melt flow properties. In the formation of GPPS pellets, melted GPPS can be extruded through a die to form GPPS strands. The GPPS strands can then be air or liquid cooled for stiffening and then cut to produce GPPS pellets of specific dimensions.

A problem associated with formation of high melt flow GPPS pellets is the GPPS can become too brittle during the pelletization process. Brittleness of GPPS is inversely proportional to its temperature; thus, the brittleness of GPPS increases as the temperature of GPPS decreases during the cooling of GPPS strands in the pelletization process. Moreover, brittleness of GPPS is directly proportional to its melt flow index (MFI); thus, the brittleness of GPPS can be higher for GPPS having higher MFI. Too brittle GPPS leads to inadequate pelletization, which causes poor product quality and even system shutdowns. Thus, when pelletizing high melt flow GPPS, special techniques are needed to control brittleness, to ensure formation of high quality pellets and to avoid system shutdowns.

### SUMMARY

One or more embodiments include a method for pelletizing high melt flow polystyrene. The method generally includes providing a polystyrene including a melt flow index of about 16 g/10 min to about 34 g/10 min; extruding a strand of the polystyrene through a die head, wherein a temperature of the polystyrene at the die head is from about 370° to about 430° F.; and moving the strand through a bath, wherein a temperature of the bath is from about 95° to about 145° F.

One or more embodiments include the method of the previous paragraph, wherein the polystyrene includes a melt flow index about 20 g/10 min to about 30 g/10 min.

One or more embodiments include the method of any preceding paragraph, wherein the temperature of the polystyrene at the die head is about 400° F. and wherein the temperature of the bath is from about 110° to about 120° F.

One or more embodiments include the method of any preceding paragraph, wherein the high melt flow polystyrene has a melt flow index of about 28 g/10 min.

One or more embodiments include the method of any preceding paragraph further including feeding the strand of polystyrene from the bath to a pelletizer.

One or more embodiments include the method of any preceding paragraph further including flowing water co-currently with the strand of polystyrene from the bath to the pelletizer.

One or more embodiments include the method of any preceding paragraph further including sloping the bath downwardly from the die head to the pelletizer.

One or more embodiments include the method of any preceding paragraph further including passing the strand of polystyrene directly from the die head to the bath; and feeding the strand of polystyrene directly from the bath to the pelletizer.

One or more embodiments include the method of any preceding paragraph further including placing an edge guide adjacent an inlet of the pelletizer; and guiding the strand into the pelletizer with the edge guide.

One or more embodiments include the method of any preceding paragraph further including placing a guide bar adjacent the die head.

One or more embodiments include the method of any preceding paragraph, wherein the temperature of the polystyrene at the die head is about 400° F. and wherein the temperature of the bath is from about 120° to about 130° F.

One or more embodiments include the method of any preceding paragraph, wherein the high melt flow polystyrene has a melt flow index of about 24.8 g/10 min.

One or more embodiments include the method of any preceding paragraph further including pelletizing the polystyrene.

One or more embodiments include the method of any preceding paragraph, where the step of pelletizing includes matching a speed of a cutter wheel in the pelletizer with a speed of an upper feed roller and with a speed of a lower feed roller; providing water-lubricated bearings for the upper feed roller and for the lower feed roller and the cutter wheel; and mounting a baffle in a cutting chamber of the pelletizer adjacent the cutter wheel.

One or more embodiments include a system for pelletizing a strand of high melt flow polystyrene. The system generally includes a die head; a sluice tray having an end positioned adjacent the die head; a guide bar positioned on the end of the sluice tray; and a pelletizer positioned to receive a strand from an opposite end of the sluice tray, wherein the pelletizer includes a cutting chamber, wherein the cutting chamber has an inlet and an outlet, the inlet to receive the strand of high melt flow polystyrene; a cutting wheel positioned within the cutting chamber, wherein the cutting wheel has teeth formed on a surface thereof; an upper feed roller positioned adjacent the cutting wheel and adjacent the inlet; a lower feed roller positioned under the upper feed roller; a baffle mounted within the cutting chamber adjacent the cutting wheel; and a stationary blade mounted within the cutting chamber adjacent the teeth of the cutting wheel.

One or more embodiments include the system of the preceding paragraph, wherein the cutting wheel has a Zerk fitting connected thereto.

One or more embodiments include the system of any preceding paragraph, wherein the opposite end of the sluice tray has a width less than a width of the end of the sluice tray, wherein the system further includes a first edge guide positioned adjacent a side of the sluice tray and adjacent the opposite end of the sluice tray; and a second edge guide positioned adjacent an opposite side of the sluice tray and adjacent the opposite end of the sluice tray.

One or more embodiments include the system of any preceding paragraph, wherein the upper feed roller includes water-lubricated bearings, wherein the lower feed roller includes water-lubricated bearings and wherein the cutter wheel comprises water-lubricated bearings.

One or more embodiments include the system of any preceding paragraph, wherein the sluice tray slopes downwardly from the end of the sluice tray to the opposite end of the sluice tray.

One or more embodiments include the system of any preceding paragraph further including a dryer positioned between the opposite end of the sluice tray and the pelletizer, wherein the dryer has a plurality of blowers to dry the strand.

### BRIEF DESCRIPTION OF DRAWINGS

FIG. 1 illustrates an elevational view of an embodiment of the disclosed system for pelletizing high melt flow polystyrene.

FIG. 2 illustrates a plan view of the embodiment of the system shown in FIG. 1.

FIG. 3 illustrates an elevational view of another embodiment of the disclosed system for pelletizing high melt flow polystyrene.

FIG. 4 illustrates a plan view of the embodiment of the system shown in FIG. 3.

FIG. 5 illustrates a cross-sectional view of a specific embodiment of the pelletizer, taken along sight-line 5-5 in FIG. 4.

### DETAILED DESCRIPTION

### Introduction and Definitions

A detailed description will now be provided. Each of the appended claims defines a separate invention, which for infringement purposes is recognized as including equivalents to the various elements or limitations specified in the claims. Depending on the context, all references below to the “invention” may m sonic cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition skilled persons in the pertinent art have given that term as reflected in printed publications and issued patents at the time of filing. Further, unless otherwise specified, all compounds described herein may be substituted or unsubstituted and the listing of compounds includes derivatives thereof.

Further, various ranges and/or numerical limitations may be expressly stated below. It should be recognized that unless stated otherwise, it is intended that endpoints are to be interchangeable. Further, any ranges include iterative ranges of like magnitude falling within the expressly stated ranges or limitations.

Embodiments described herein generally include methods and systems for pelletizing high melt flow polystyrene. The high melt flow polystyrene may include any polystyrene exhibiting a melt flow index (MFI) (as measured by ASTM D 1238 condition 200° C./5 kg) of about 16 g/10 min to about 34 g/10 min, or of about 20 g/10 min to about 30 g/10 min, for example. As used herein, the MFI is a measurement prior to extrusion at the die head (unless specified otherwise), such extrusion being discussed further below.

In one or more embodiments, the high melt flow polystyrene may be general purpose polystyrene (GPPS). General purpose polystyrene may be formed by methods known to one skilled in the art, such as suspension polymerization, for example. In one or more embodiments, the formed polystyrene may be a homopolymer. In other embodiments, the formed polystyrene may optionally incorporate one or more comonomers. The comonomers may include alkylstyrenes, divinylbenzene, acrylonitrile, diphenyl ether, alpha-methylstyrene or combinations thereof, for example. In one or more embodiments, the formed polystyrene may include from about 0 wt. % to about 30 wt. %, or from about 0.1 wt. % to about 15 wt. % or from about 1 wt. % to about 10 wt. % comonomer, for example. In one or more embodiments, the high melt flow polystyrene may be formed by the processes disclosed in U.S. Patent Publication Serial No. 2010/0222532, which is incorporated herein by reference.

For a given MFI, molecular weight (M_{W}) may generally be calculated according to the corresponding formulas for polystyrene with monomodal molecular weight distribution (Equation 1) and for mixtures or blends M_{W} can be calculated, where C₁ is the weight fraction of component 1 (Equation 2):

MFI=(10¹⁹)M_{W}^{-3.41}; Equation 1

M_{W}=C₁(M_{W})₁+(1−C₁) (M_{W})₂; Equation 2.

Accordingly, the high melt flow polystyrene may exhibit a M_{W} (as measured by GPC) of from about 10,000 Dalton to about 100,000 Dalton, for example.

The high melt flow polystyrene may exhibit a density of from about 0.1 lb/ft³ to about 10 lb/ft³, or from about 0.4 lb/ft³ to about 1 lb/ft³ or from about 0.5 lb/ft³ to about 0.8 lb/ft³, for example.

High melt flow polystyrene may exhibit a level of brittleness that is too high for pelletization. As used herein, the term “brittleness” is measured by % elongation at fail and when brittleness increases, % elongation decreases. In one or more embodiments, the high melt flow polystyrene may exhibit a % elongation at fail of at least 0.1, or from about 0.1 to about 2.0, for example, in order to avoid excessive brittleness.

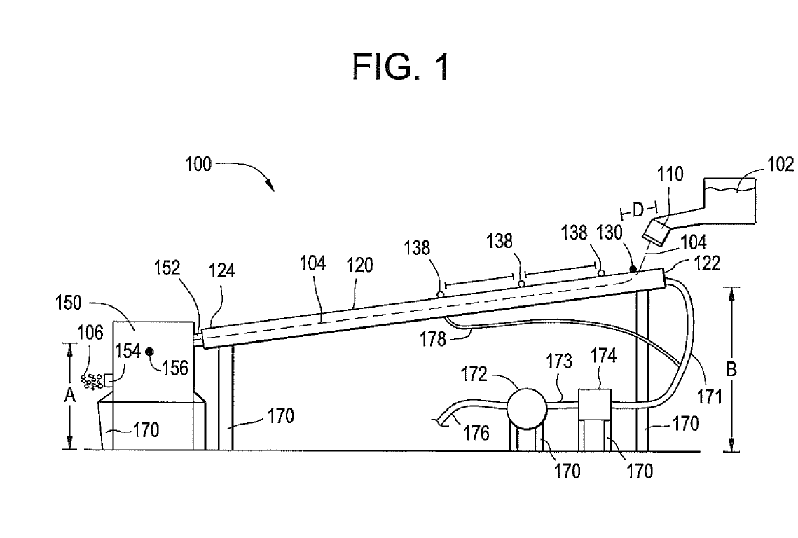

FIG. 1 illustrates an elevational view of an embodiment of the disclosed system 100 for pelletizing high melt flow polystyrene. The system 100 may be termed a “wet cut” system for pelletizing the polystyrene. The system 100 may have a die head 110, a sluice tray 120, and a pelletizer 150.

The die head 110 may be connected to a source 102 of high melt flow polystyrene. The die head 110 may be positioned over an end 122 of the sluice tray 120. In one or more embodiments, a temperature of the high melt flow polystyrene at the die head 110 may be about 370° to about 430° F., or about 395° to about 405° F., or about 400° F., for example.

The end 122 of the sluice tray 120 may be positioned adjacent the die head 110, and an opposite end 124 of the sluice tray 120 may he positioned adjacent an inlet 152 of the pelletizer 150. A bath may be provided in the sluice tray 120, and in one or more embodiments, the temperature of the bath may be about 95° to about 135° F., or about 110° to about 120° F., for example. The fluid used in the bath may be water. The strands 104 may be submerged underwater in the bath for the distance between the guide bar 130 and the opposite end 124 of the sluice tray 120.

The temperature of the high melt flow polystyrene at the die head 110 generally depends on the MFI of the high melt flow polystyrene, and polystyrene having a higher MFI requires a lower temperature of the high melt flow polystyrene at the die head 110 and a higher temperature of water in the bath in the sluice tray 120. It has been found that observing a sag of the strands 104 between the die head 110 and the guide bar 130 may provide an indication of the MFI of the strands 104, and the temperature of the high melt flow polystyrene at the die head 110 and the temperature of the water in the bath in the sluice tray may be adjusted according to the sag of strands 104 between the die head 110 and the guide bar 130.

The pelletizer 150 may be a wet-cut pelletizer 150 for system 100 in that the strands 104 may be cut in water inside the pelletizer 150. Water and pellets 106 may exit the pelletizer 150 through outlet 154. Zerk fitting 156 may be used to externally lubricate components of the cutting wheel which is located internally of the pelletizer 150.

In one or more embodiments, end 122 of the sluice tray 120 may have a height B, which is greater than a height A of the opposite end 124 of the sluice tray 120 so that the sluice tray 120 may slope downwardly from the end 122 of the sluice tray 120 to the opposite end 124 of the sluice tray 120. The height B of end 122 of sluice tray 120 may be greater than height A of opposite end 124 sluice tray 120 so that the downward slope of the sluice tray 120 is at least 5 degrees or from about 5 degrees to about 30 degrees or about 15 degrees, for example.

In one or more embodiments, a guide bar 130 may be positioned on top of the sluice tray 120 adjacent the end 122 of the sluice tray 120. The guide bar 130 may be positioned a distance D from an end 122 of the sluice tray 120. Distance D may be from about 5 inches to about 30 inches, or from about 10 inches to about 20 inches or about twelve inches, for example. The guide bar 130 may guide extruded strands 104 of high melt flow polystyrene into submersion in the bath in the sluice tray 120.

In one or more embodiments, spray bars 138 may be positioned on the sluice tray 120. The spray bars 138 are generally positioned a distance from the end 122 of the sluice tray 120 that is greater than a distance the guide bar 130 is from the end 122 of the sluice tray 120. FIG. 1 shows three spray bars 138, but it should be understood more or fewer spray bars 138 may be included in the system 100. The spray bars 138 spray water onto the extruded strands 104 moving from end 122 of sluice tray 120 to the opposite end 124 of the sluice tray 120. The distance C between the spray bars 138 may be from about 20 inches to about 40 inches, or from about 25 inches to about 30 inches or about 27 inches, for example.

In one or more embodiments, the system 100 may have a water supply for the bath. Water may flow in line 178 to the spray bars 138 and in line 171 to the end 122 of the sluice tray 120. Water may flow from a source (not shown) in line. 176 to a pump 172, where the water is pumped in line 173 to a heat exchanger 174. The heat exchanger 174 may regulate the temperature of the bath in the sluice tray 120 from about 95° to about 145° F., or from 110° to about 120° F. for example. Water may flow in line 171 to the end 122 of the sluice tray 120, and water may flow in line 178 to the spray bars 138 so that the spray bars 138 can spray water on the extruded strands 104.

For illustration purposes only, strands 104 are shown in FIG. 1 as extruding from the die head 110 as a solid line. Strands 104 are shown in FIG. 1 as moving in the sluice tray 120 as a dashed line. Legs 170 support the pelletizer 150, sluice tray 120, pump 172, and heat exchanger 174 above the ground.

It has been found that the specified temperatures of the high melt flow polystyrene at the die head 110 and in the bath in the sluice tray 120 maintain the % elongation of the strands 104 above 0.1 (i.e., keep the strands 104 of high melt now polystyrene from being too brittle for pelletization in the pelletizer 150). These operating conditions keep the strands 104 from becoming too brittle for pelletization in a wet-cut system 100 with source 102 of high melt flow polystyrene having an MFI of about 16 to about 34 g/10 min. Without these operating conditions, the system 100 does not run for a long time without system shutdown and unreliable quality of pellets; thus, these operating conditions enable the system 100 to operate long enough to profitably produce high melt polystyrene pellets 106. The temperature of the bath in the sluice tray 120 also ensures a proper cooling rate of the strands 104 to prevent strands from sticking together (too hot of a strand) or breaking (too cold of a strand). The temperature of the high melt flow polystyrene at the die head 110 ensures the strands 104 are not too stiff (too cold of a strand, which leads to breakage) or too saggy (too hot of a strand, which leads to strand patties and shutdowns). The above-disclosed temperatures of the polystyrene at the die head 110 and the temperature of the bath in the sluice tray 120 ensure a proper sag of strands 104 between the die head 110 and the guide bar 130 for an extrusion rate of strands 104 of about 5,000 to about 28,000 lb/hr.

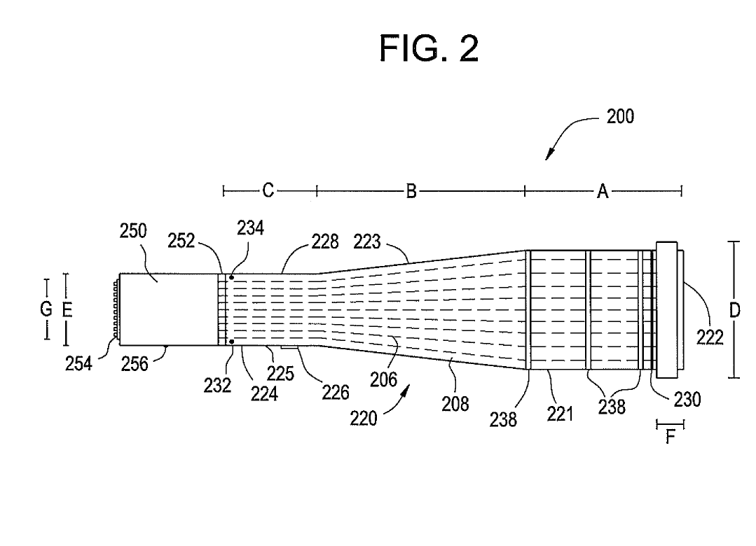

FIG. 2 illustrates a plan view of the embodiment of the system 100 shown in FIG. 1. In one or more embodiments of the system 200 shown in FIG. 2, the opposite end 224 of the sluice tray may have a width less than a width of the end 222 of the sluice tray.

In one or more embodiments, the sluice tray 220 may have a first portion 221, a second portion 223, and a third portion 225. The second portion 223 may be positioned between the first portion 221 and the third portion 225, and the three portions 221, 223, and 225 form the sluice tray 120. The first portion 221 may have a length A, the second portion 223 may have a length B, and the third portion 225 may have a length C. Length A may be greater than length C, and length B may be greater than length A. For example, length A may be from about 65 inches to about 90 inches, or from about 70 inches to about 80 inches or about 71 inches. Length B may be from about 80 inches to about 100 inches, or from about 90 inches to about 98 inches or about: 96 inches, and length C may be from about 15 inches to about 30 inches or from about 20 inches to about 35 inches or about 24 inches, for example. The sides of first portion 221 may be generally parallel to one another, and the sides of third portion 225 may be generally parallel to one another; however, the width D of the first portion 221 may be greater than the width E of the third portion 225. The side of the second portion 223 may taper from the width D to the width E. Thus, the distance between the strands 204 decreases and the strands 204 move closer together as they move through the second portion 223 from the first portion 221 to the third portion 225. Width D may also be the width of the pelletizer 250. When in the first portion 221 and the third portion 225 of the sluice tray 220, the strands 204 are generally parallel to one another. When in the second portion 223 of the sluice tray 220, the strands 204 are generally at an angle with respect to one another.

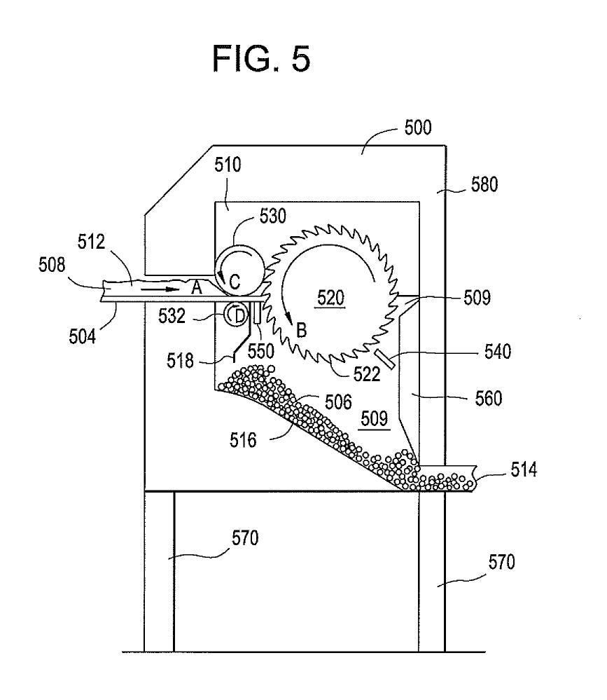

In one or more embodiments, the sluice tray 220 may include one or more edge guides 232 and 234. Edge guide 232 may be placed adjacent the inlet 252 of the pelletizer 250, adjacent to the opposite end 224 of the sluice tray 220, and adjacent side 226 of the sluice tray 220. Edge guide 234 may be placed adjacent the inlet 252 of the pelletizer 250, adjacent to the end 222 of the sluice tray 220, and adjacent opposite side 228 of the sluice tray 220. The edge guides 232 and 234 may be placed in the third portion 225 of the sluice tray 220. The edge guides 232 and 234 prevent misalignments during cutting of the strands 204 to make pellets 206. The edge guides 232 and 234 are spaced apart by distance G, which corresponds to length of the upper and lower feed rollers (discussed in FIG. 5) in the pelletizer 250. The edge guides 232 and 234 thus keep the strands 204 from moving beyond the end of the rollers and ensure the strands arc properly aligned to be cut in the pelletizer 250.

In one or more embodiments, the pelletizer 250 of system 200 may include a Zerk fitting 256 for external lubrication of the cutting wheel internally located in the pelletizer 250. Pellets 206 may discharge or exit from the pelletizer 250 in outlet 254.

In one or more embodiments, the guide bar 230 of the system 100 may be placed in the first portion 221 of the sluice tray 220, about 12 inches from end 222 of the sluice tray 220, indicated by distance F in FIG. 2. The guide bar 230 provides support for the strands 204 as the travel into the bath 208 in the sluice tray 220. Moreover, the guide bar 230 provides separation of adjacent strands 204 (prevents sticking) as the strands 204 enter the bath 208 and cool.

Spray bars 238 may be placed on the first portion 221 of the sluice tray 220. Spray bars 238 may also be placed on the second portion 223 and third portion 225 of the sluice tray 220, if needed. Three spray bars 238 are included in FIG. 2, however, it should be understood more or fewer spray bars 238 may he included. Strands 204 are shown in FIG. 2 as dashed lines in order to differentiate the strands 204 from the other components of the system 200.

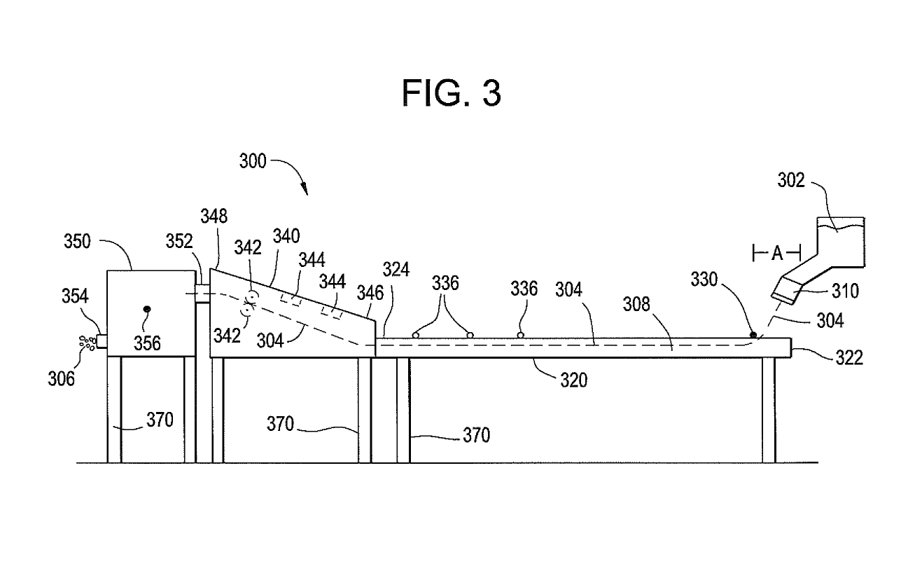

FIG. 3 illustrates an elevational view of another embodiment of the disclosed system 300 for pelletizing high melt flow polystyrene. The system 300 may he termed a “dry cut” system for pelletizing the polystyrene. The system 300 may have a die head 310, a sluice tray 320, a dryer 340, and a pelletizer 350.

The die head 310 may be connected to a source 302 of high melt flow polystyrene. The die head 310 may be positioned over an end 322 of the sluice tray 320. In one or more embodiments, a temperature of the high melt now polystyrene at the die head 310 may be about 370° to about 430° F., or about 395° to about 405° F., or about 400° F., for example.

The end 322 of the sluice tray 320 may be positioned adjacent the die head 310, and an opposite end 324 of the sluice tray 320 may be positioned adjacent an inlet 352 of the pelletizer 350. A bath may be provided in the sluice tray 320, and in one or more embodiments, the temperature of the bath may be about 105° to about 145° F., or about 120° to about 130° F., for example. The fluid used in the bath may be water. The strands 304 maybe be submerged underwater in the bath for the distance between the guide bar 330 and the opposite end 324 of the sluice tray 320. Optionally, the strands 304 may be submerged underwater in the bath for the distance between the guide bar 330 and one of the support bars 336 that holds the strands 304 over and out of the bath in the sluice tray 320.

Similar to the embodiment shown in FIG. 1, it has been found that, in the embodiment shown in FIG. 3, observing a sag of the strands 304 between the die head 310 and the guide bar 330 may provide an indication of the MFI of the strands 304, and the temperature of the high melt flow polystyrene at the die head 310 and the temperature of the water in the bath in the sluice tray may be adjusted according to the sag of strands 304 between the die head 310 and the guide bar 330. The above-disclosed temperatures of the polystyrene at the die head 310 and the temperature of the bath in the sluice tray 320 ensure a proper sag of strands 304 between the die head 310 and the guide bar 330 for an extrusion rate of strands 104 of about 5,000 to about 17,000 lb/hr.

In contrast to the embodiment of the system 100 shown in FIG. 1, the system 300 shown in FIG. 3 may have a horizontal bath in the sluice tray 320. That is, end 322 of the sluice tray 320 may be the same height as the opposite end 324 of the sluice tray 320.

In one or more embodiments, a guide bar 330 may be positioned on top of the sluice tray 320 adjacent the end 322 of the sluice tray 320. The guide bar 330 may be positioned a distance A from the end 322 of the sluice tray 320. Distance A may be from about 5 inches to about 20 inches, or from about 10 inches to about 15 inches or about twelve inches, for example. The guide bar 330 may guide extruded strands 304 of high melt flow polystyrene into submersion in the bath 308 in the sluice tray 320.

In one or more embodiments, the system 300 may include support bars 336 that may support the strands 304 above the bath in the sluice tray 320. The support bars 336 raise the strands 304 out of the bath in the sluice tray 320; thus, the strands 304 may begin drying while moving along the sluice tray 320.

In one or more embodiments, a dryer 340 may be positioned between the opposite end 324 of the sluice tray 320 and the pelletizer 350. The dryer 340 may include blowers 344 to dry the strands 304. Guide members 342 may be positioned in the dryer 340 to guide the strands 304 from end 346 of the dryer 340 to opposite end 348 of the dryer 340. End 346 of the dryer 340 may have a height less than a height of an opposite end 348 of the dryer 340. Thus, the profile of the dryer 340 shown in FIG. 3 tapers upwardly from end 346 to opposite end 348.

In one or more embodiments, the dryer 340 is positioned adjacent the inlet 352 of the pelletizer 350. Strands 304 pass from the opposite end 348 of the dryer 340 to the inlets 352 of the pelletizer 350, where the strands 304 of high melt flow polystyrene are pelletized into pellets 306. The pellets 306 exit the pelletizer 350 through outlet 354. Strands 304 are cut into pellets 306 in the pelletizer 350 in a dry cut environment, i.e. without water from the bath in the sluice tray 320.

Legs 370 support the pelletizer 350, dryer 340, and sluice tray 320 above the ground. Zerk fitting 356 may be used to externally lubricate components of the cutting wheel which is internally located in the pelletizer 350.

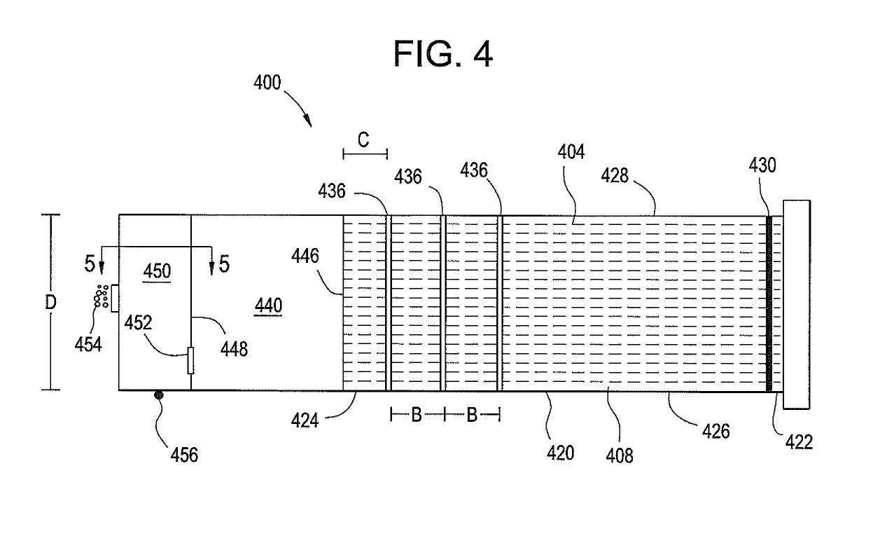

FIG. 4 illustrates a plan view of the system 300 and process 301 shown in FIG. 3. In one or more embodiments, the guide bar 430 of the system 400 shown in FIG. 4 may be placed on the sluice tray 420, from about 5 inches to about 30 inches or about 12 inches from end 422 of the sluice tray 420, indicated by distance A in FIG. 4. The guide bar 430 provides support for the strands 404 as the travel into the bath 408 in the sluice tray 420. Moreover, the guide bar 430 provides separation of adjacent strands 404 (prevents them from sticking to one another) as the strands 404 enter the bath 408 and cool.

In dry-cutting system 400, the sluice tray 420 may have a constant width D from end 422 to opposite end 424 of the sluice tray 420; thus, side 426 of the sluice tray 420 is parallel to side 428 of the sluice tray 420. The dryer 440 also may have a constant width D from end 446 to opposite end 448 of the dryer 440. The pelletizer 450 may have a constant width D from inlet 452 to outlet 454. The external Jerk fitting 456 can be seen on the exterior of the pelletizer 450.

In one or more embodiments, support bars 436 may be placed on the sluice tray 420 closer to opposite end 424 of the sluice tray 420 than to end 422 of the sluice tray 420. Three support bars 436 arc included in FIG. 4, however, it should be understood more or fewer support bars 436 may be included in the system 400. The space between support bars 436 may be adjusted accordingly to support the strands 404 of high melt flow polystyrene above the water bath in the sluice tray 420. When supported by support bars 436, the path of strands 404 arches downwardly between adjacent support bars 436; thus, the space between the support bars 436 may be determined by the properties of the strands 404, such as % elongation, temperature, and melt flow index. The distance C between the support bar 436 closest to the end 446 of dryer 440 and the dryer 440 may be the same as or different than distance 13 between adjacent support bars 436. Strands 404 are shown in FIG. 4 as dashed lines in order to differentiate the strands 404 from the other components of system 400.

FIG. 5 illustrates an cross-sectional view of a specific embodiment of the pelletizer 500 used in the disclosed methods and systems for pelletizing high melt flow polystyrene, taken along sight-line 5-5 shown in FIG. 4. The pelletizer 500 may have a cutting chamber 510, an inlet 512 to the cutting chamber 510, an outlet 514 of the cutting chamber 510, a cutting wheel 520 positioned within the cutting chamber 510, an upper feed roller 530 positioned adjacent the cutting wheel 520 and adjacent the inlet 512, a lower feed roller 532 positioned under the upper feed roller 530, a baffle 540 mounted within the cutting chamber 510 adjacent the cutting wheel 520, and a stationary blade 550 mounted within the cutting chamber 510. The cutting wheel 520 may have teeth 522 on a surface thereof, and the stationary blade 550 may be positioned adjacent the teeth 522 of the cutting wheel 520. The cutting wheel 520, upper feed roller 530, and lower feed roller 532 have a longitudinal axes parallel to one another. The longitudinal axes of the cutting wheel 520, upper feed roller 530, and lower feed roller 532 are orthogonal to the longitudinal axes of the strands 504 of high melt flow polystyrene.

The inlet 512 may receive strands 504 of high melt flow polystyrene, and the strands 504 enter the pelletizer 500 in generally parallel orientation with respect to one another. Strands 504 pass into the pelletizer 500 in the direction indicated by arrow A. If the pelletizer 500 is used with a wet-cut system such as system 100 in FIG. 1, water 508 from the bath in the sluice tray flowing with the strands 504 in the direction indicated by arrow A. The inlet 512 may receive strands 504 of polystyrene without water if the pelletizer 500 is used with a dry-cut system. The inlet 512 and outlet 514 of the pelletizer may be formed of stainless steel. Water 509 may accumulate in the cutting chamber 510 and discharge with the pellets 506 through outlet 514.

The cutting chamber 510 may house the cutting wheel 520, upper feed roller 530, lower feed roller 532, baffle 540, and stationary blade 550 therein. The cutting chamber 510 may be sound isolated from a body 580 of the pelletize 500 so as to reduce noise made in cutting pellets 506 of high melt flow polystyrene. The cutting chamber 510 may be in operable communication with any of the sluice trays 120/220/320/420 shown in FIGS. 1 through 4.

In one or more embodiments, the cutting wheel 520 may have teeth 522 formed on a surface thereof. The teeth 522 may have a helix angle. The helix angle of the teeth 522 provides for noise attenuation when cutting pellets 506 from the strands 504. The cutting wheel 520 may be formed of stainless steel, and the teeth 522 of the cutting wheel 520 may be covered with stellite-12. The stellite-12 keeps the teeth 522 of the cutting wheel 520 sharp for longer and reduces the noise made when the teeth 522 cut the strands 504 into pellets 506. The cutting wheel 520 may have spherical bearings, and may have six such bearings, for example, with each bearing having a B-10 bearing life greater than 100,000 hours. The cutting wheel 520 may have a Zerk fitting connected thereto (shown in FIGS. 1 through 4) for lubricating the bearings of the cutting wheel 520 from externally of the pelletizer 500. Cutting wheel 520 may rotate in a counter-clockwise fashion in the direction shown by the curved arrow B when seen in the cross-sectional view in FIG. 5. The cutting wheel 520 may optionally be made of D-2 steel, stellite, or solid carbide.

In one or more embodiments, the upper feed roller 530 may have water-lubricated bearings, the lower feed roller 532 may have water-lubricated bearings as well, and the cutter wheel 520 may have water-lubricated hearings. Water-lubricated bearings help to prevent water failures common for grease-type bearings. Water-lubricated bearings also extend run-time of the pelletizer 500 over prior pelletizers utilizing grease-lubricated bearings (sealed or unsealed). The upper feed roller 530 may have a larger diameter than a diameter of the lower feed roller 532. The larger diameter of the upper feed roller 530 increases the nipping on the surface of the strands of high melt flow polystyrene. The larger diameter of the upper feed roller 530 also provides a roller with a larger mass that is more resistant to movement due to loads and keeps the strands in alignment in the pelletizer 500. The upper feed roller 530 and lower feed roller 532 may have a surface covered with a material that is not too hard for high melt flow polystyrene strands, such as a suitable rubber or metal. Metal surfaces may be textured, and rubber surfaces may be placed on a stainless steel shaft. Depending on the MFI of the high melt flow polystyrene, the surfaces of the upper feed roller 530 and lower feed roller 532 may both be metal, or a surface of lower feed roller 532 may be metal and a surface of upper feed roller 530 may be rubber, for example. For polystyrene having a high MFI, lower feed roller 532 may have a solid stainless steel textured surface, and the upper feed roller 530 may have a rubber surface mounted on a stainless steel shaft, for example. The rubber surface of the upper feed roller 530 may have a Durometer type-A hardness of about 65 to about 90. A proper hardness is important because too soft of a material causes grooving in the rubber roller which causes strands to cross each other and leads to reliability problems, while too hard a material prevents proper strand grip and causes strand slippage and even strand breakage.

In one or more embodiments, the lower feed roller 532 may have a surface that is textured, such as knurled or serrated. The upper feed roller 530 and lower feed roller 532 may have matched surface speeds through modified gearing. The surface speed of the upper and lower teed roller 530 and 532 may have matching surface speed within 1% of one another, for example. The matched surface speeds of the rollers 530 and 532 may match the tip speed of the cutter wheel 520. The surface speed of the upper and lower feed roller 530 and 532 and the tip speed of the cutting wheel 520 may have matching speeds within 1% of one another, for example. Prior systems utilize different speed for the rollers 530 and 532 and the cutting wheel 520, and it has been found that matching the surface and tip speeds prevents bending of the strands and other cutting problems in the pelletizer 500.

Optionally, the upper feed roller 530 may be driven or may be idle. Upper feed roller 530 may rotate in a counterclockwise fashion in the direction shown by curved arrow C when seen in the cross-sectional view in FIG. 5. Lower feed roller 532 may rotate in a clockwise fashion in the direction shown by the curved arrow D when seen in the cross-sectional view in FIG. 5.

In one or more embodiments, the pelletizer 500 may include a stationary blade 550. The stationary blade 550 is positioned in the cutting chamber 510 between the cutting wheel 520 and the lower feed roller 532. The stationary blade 550 of the pelletizer 500 may be made of a stainless steel material. Moreover, the stationary blade 550 may have four cutting edges, and the stationary blade 550 may be covered with stellite-12. The stellite-12 keeps the stationary blade 550 sharp for longer and reduces the noise made when the stationary blade 550 cuts the strands 504. The stationary blade 550 may have key tolerances and gap settings with respect to the cutting wheel 520. The stationary blade 550 reduces fines, improves reliability of the pelletizer 500, and improves the run-time of the pelletizer 500.

In one or more embodiments, the pelletizer 500 may include a baffle 540. The baffle 540 of the pelletizer may be mounted in the cutting chamber 510. In FIG. 5, the baffle 540 may be mounted below the cutting wheel 520 to reduce recycling (carry-over) of pellets 506 and fines inside the pelletizer 500. The baffle 540 angles upwardly within the chamber 510 and may be placed adjacent to the teeth 522 of the cutting wheel 520 so that pellets 506 are unlikely to travel between the baffle 540 and the cutting wheel 520 so as to cause carry-over. In the event carry-over occurs, the pelletizer 500 include a member 518 that may guide carry-over pellets 506 and fines to the bottom 516 of the cutting chamber 510 where the bulk of pellets 506 are collected for discharge through outlet 514. Moreover, the baffle 540 reduces fines and extends run-time of the pelletizer 500.

In one or more embodiments, the pelletizer 500 may include a protrusion member 560 to guide pellets 506 toward the outlet 514. The bottom 516 of the cutting chamber 510 is angled to guide pellets 506 toward the outlet 514. The protrusion member 560 and bottom 516 angle to form a chute for gravity discharge of the pellets 506 and water 509 from the pelletizer 500.

Pellets 506 and water 509 may exit from the pelletizer 500 in outlet 514, and pellets 506 and water 509 subsequently flow to a separator (not shown) where the pellets 506 and water 509 are separated and the pellets 506 are dried.

In one or more embodiments, the pelletizer 500 may include pneumatic cylinders and heavy-duty bearings that absorb the shock from loading of strands 504 into the pelletizer 500 during startup. Clap setting and tolerances on pneumatic cylinders for the upper feed roller 530 improve performance and reliability. The pelletizer 500 provides for routine maintenance of machine tolerances and gaps. For example, external access to the jerk fitting for lubricating the cutting wheel 520 helps maintain operations during preventative work on the pelletizer 500. Legs 570 support the pelletizer 500 above the ground.

While the foregoing is directed to embodiments of the present invention, other and further embodiments of the invention may be devised without departing from the basic scope thereof and the scope thereof is determined by the claims that follow.

What is claimed is:

1. A method for pelletizing high melt flow polystyrene comprising:
providing a polystyrene comprising a melt flow index of about 16 g/10 min to about 34 g/10 min;
extruding a strand of the polystyrene through a die head, wherein a temperature of the polystyrene at the die head is about 370° to about 430° F.; and
moving the strand through a bath, wherein a temperature of the bath is about 95° to about 145° F.

2. The method of claim 1, wherein the polystyrene comprises a melt flow index about 20 g/10 min to about 30 g/10 min.

3. The method of claim 1, wherein the temperature of the polystyrene at the die, head is about 400° F. wherein the temperature of the bath is about 110° to about 120° F.

4. The method of claim 3, wherein the high melt flow polystyrene has a melt flow index of about 28 g/10 min.

5. The method of claim 1, further comprising:
feeding the strand of polystyrene from the bath to a pelletizer.

6. The method of claim 5, further comprising:
flowing water co-currently with the strand of polystyrene from the bath to the pelletizer.

7. The method of claim 5, further comprising:
sloping the bath downwardly from the die head to the pelletizer.

8. The method of claim 5, further comprising:
passing the strand of polystyrene directly from the die head to the bath; and
feeding the strand of polystyrene directly from the bath to the pelletizer.

9. The method of claim 5, further comprising:
placing an edge guide adjacent an inlet of the pelletizer; and
guiding the strand into the pelletizer with the edge guide.

10. The method of claim 1, further comprising:
placing a guide bar adjacent the die head.

11. The method of claim 1, wherein the temperature of the polystyrene at the die head is about 400° F., wherein the temperature of the bath is about 120° to about 130° F.

12. The method of claim 11, wherein the high melt flow polystyrene has a melt flow index of about 24.8 g/10 min.

13. The method of claim 5, further comprising:
pelletizing the polystyrene.

14. The method of claim 13, where the step of pelletizing comprises:
matching a speed of a cutter wheel in the pelletizer with a speed of an upper feed roller and with a speed or a lower feed roller;
providing water-lubricated bearings for the upper feed roller and for the lower feed roller and the cutter wheel: and
mounting a baffle in a cutting chamber of the pelletizer adjacent the cutter wheel.

15. A system for pelletizing a strand of high melt flow polystyrene comprising:
a die head;
a sluice tray having an end positioned adjacent the die head;
a guide bar positioned on the end of the sluice tray; and
a pelletizer positioned to receive a strand from an opposite end of the sluice tray, wherein the pelletizer comprises:
a cutting chamber, wherein the cutting chamber has an inlet and an outlet, the inlet to receive the strand of high melt flow polystyrene;
a cutting wheel positioned within the cutting chamber, wherein the cutting wheel has teeth formed on a surface thereof;
an upper feed roller positioned adjacent the cutting wheel and adjacent the inlet;
a lower feed roller positioned under the upper feed roller;
a baffle mounted within the cutting chamber adjacent the cutting wheel; and
a stationary blade mounted within the cutting chamber adjacent the teeth of the cutting wheel.

16. The system of claim 15, wherein the cutting wheel has a Zerk fitting connected thereto.

17. The system of claim 15, wherein the opposite end of the sluice tray has a width less than a width of the end of the sluice tray, wherein the system further comprises:
a first edge guide positioned adjacent a side of the sluice tray and adjacent the opposite end of the sluice tray; and
a second edge guide positioned adjacent an opposite side of the sluice tray and adjacent the opposite end of the sluice tray.

18. The system of claim 15, wherein the upper feed roller comprises water-lubricated bearings, wherein the lower feed roller comprises water-lubricated bearings, wherein the cutter wheel comprises water-lubricated bearings.

19. The system of claim 15, wherein the sluice tray slopes downwardly from the end of the sluice tray to the opposite end of the sluice tray.

20. The system of claim 15, further comprising:
a dryer positioned between the opposite end of the sluice tray and the pelletizer, wherein the dryer has a plurality of blowers to dry the strand.
